(19) United States
(12) Patent Application Publication
(10) Pub. No.: US 2011/0051616 A1
(43) Pub. Date: Mar. 3, 2011

(54) WIRELESS TERMINAL DEVICE, WIRELESS COMMUNICATION SYSTEM, AND METHOD OF NOTIFYING COMMUNICATION STATUS LEVEL

(75) Inventors: Tetsuya INADA, Nagoya (JP); Masao YAMAGUCHI, Nagoya (JP)

(73) Assignee: BUFFALO INC., Nagoya-shi (JP)

(21) Appl. No.: 12/871,744

(22) Filed: Aug. 30, 2010

(30) Foreign Application Priority Data
Aug. 31, 2009 (JP) 2009-199563

(51) Int. Cl. H04L 12/26; H04W 84/02

(52) U.S. Cl. 370/252; 370/338

(57) ABSTRACT

A wireless terminal device 110 for communicating with an access point 200 through the MIMO protocol, comprising a throughput measurement module 132 for measuring the throughput during the communication with the access point 200, and an indicator unit 13 for notifying the user of the level of the status of communication with the access point 200 according to the result of measurements obtained by the throughput measurement module 132.

### CROSS-REFERENCE TO RELATED APPLICATIONS

The present application claims the priority based on Japanese Patent Application No. 2009-199563 filed on Aug. 31, 2009, the disclosure of which is hereby incorporated by reference in its entirety.

### BACKGROUND OF THE INVENTION

1. Field of the Invention

The present invention relates to a wireless LAN that utilizes wireless communications.

2. Description of the Related Art

In a wireless LAN, data communication takes place on radio waves between an access point (wireless LAN host) that is connected to a network, and a wireless terminal device (wireless LAN client) such as a wireless LAN card (see, for example, JP-A 2008-72487). One known communication format for wireless LANs is the MIMO (Multi Input Multi Output) protocol.

In MIMO protocol wireless communications, the wireless LAN host and the wireless LAN clients are respectively provided with multiple antennas, and radio waves are sent and received by these antennas in order to achieve faster and more stable communications. Put it concretely, multiple signals generated by dividing a series of transmission data into multiple segments are transmitted simultaneously in the same frequency band by the antennas on the transmitting side. At the receiving end, the transmission matrix characteristic of the communication channel between the transmission and receiving sites is estimated on the basis of the distortions observed between the direct and reflected radiowaves received by the antennas on the receiving side, and the received signals consisting of the direct and reflected radiowaves are restored to the original multiple signals, which are synthesized to obtain the expected data to be received.

It is to be noted that some wireless LAN client devices have the function of notifying the user of the level of quality of the on-going communication with the wireless LAN host in order to provide the user with enhanced convenience in wireless communications. Communication status level notification is typically based on the measurement of electric field intensity (strength of received radio waves).

However, even where communication status level based on electric field intensity is notified as being good, substantial declines in communication status level may occur such that communication speed drops, or connections are interrupted, depending on the environment in which wireless communication takes place. In general, it is known that substantial declines in communication status level occur where wireless communications take place in such environments as follows. That is to say, wireless communications susceptible to this problem include those in environments where other wireless communications are also taking place in the same or neighboring channels; in environments where machines or devices generate noise in the frequency band for wireless communications; or in environments where there are buildings using steel frames that reflect radio waves.

Particularly in the case of communications employing the MIMO protocol described above, the correlation between electric field intensity and communication status level becomes still poorer because reflected waves are utilized in addition to direct waves. And there has hitherto been devised no satisfactory approach to appropriately notifying the users of communication status levels in MIMO protocol wireless communications.

### SUMMARY OF THE INVENTION

By taking into account the issue discussed above, there is a requirement for enhancing the user convenience in MIMO protocol wireless communications through appropriately notifying the user of the communication status level.

The present invention accomplishes at least part of the requirement mentioned above and the other relevant requirements by the following configurations and arrangements.

### Application Example 1

There is provided a wireless terminal device for communicating with an external wireless communication device through MIMO protocol, comprising:

a throughput measurement for measuring the throughput of the process of communication with the wireless communication device; and

a level notifier for notifying a user of the level of the status of communication with the wireless communication device according to the result of the measurement by the throughput measurement.

According to this wireless terminal device, since the user is properly notified of the level of the status of communication with an external wireless terminal device according to the results of measurements taken by the throughput measurement, the user convenience in wireless communications is improved.

### Application Example 2

There is provided the wireless terminal device according to Application Example 1, wherein the level notifier:

causes the throughput measurement to initiate the process of measuring the throughput in response to an instruction from the user;

initiates the process of notifying the communication status level according to the throughput measurement result; and

continues the measurement process and the notification process only during the measurement time adjusted according to the throughput measurement result.

While the measurement process by the throughput measurement and the notification process by the level notifier are under way, the user can adjust the position, posture and antenna orientations of the wireless terminal device while referring to the notified communication status level. According to this wireless terminal device, since the time interval during which these processes are under way is adjusted automatically according to the communication status level, the throughput measurement process and the notification process can be prevented from continuing uselessly, or from terminating against the user's intention. User convenience in wireless communications can be enhanced thereby.

### Application Example 3

There is provided the wireless terminal device according to Application Example 1 or 2, wherein

the level notifier notifies the user of whether the change in the communication status level exhibits an upgrading tendency or a degrading tendency.

According to this wireless terminal device, the user can readily ascertain the effect of improving the location, posture and antenna orientations of the wireless terminal device by the user's adjustment. Accordingly, the user convenience in wireless communications can be further enhanced.

### Application Example 4

There is provided a wireless communication system comprising:

a wireless terminal device according to Application Examples 1 through 3; and

an access point capable of wireless communication with the wireless terminal device through MIMO protocol.

According to this wireless communication system, the communication status level is properly notified to the user according to the results of the measurements by the throughput measurement unit during communications between a wireless terminal device and an access point through MIMO protocol. Accordingly, user convenience in wireless communications can be enhanced.

### Application Example 5

There is provided a method of notifying the status level of communication with an external wireless communication device to the user, the method being used in a wireless terminal device that communicates with the wireless communication device through MIMO protocol, and the method comprising the steps of:

(a) calculating the throughput of the communication with the wireless communication device; and

(b) notifying the communication status level according to the throughput measurement result.

These and other objects, features, aspects, and advantages of the present invention will become more apparent from the following detailed description of the preferred embodiments with the accompanying drawings.

The present invention can also be embodied as, for example, a wireless terminal device and a wireless communication system; a method of notifying the communication status level in wireless communications; a method or device therefore; a computer program for performing the functions of a system; or storage medium having the computer program recorded therein.

### BRIEF DESCRIPTION OF THE DRAWINGS

FIG. 1 is a schematic view of a wireless LAN system configuration in a first embodiment;

FIG. 2 is a block diagram showing the internal configuration of a wireless terminal device and a terminal PC in the first embodiment;

FIG. 3 is a block diagram showing the internal configuration of an access point in the first embodiment;

FIG. 4 is a flowchart showing the procedure of communication status level notification in the first embodiment;

FIG. 5A schematically illustrates an example of a communication status level display by an indicator unit in the first embodiment;

FIG. 5B is a model diagram illustrating an indicator unit in a comparative example;

FIG. 5C is a model diagram illustrating an indicator unit in a comparative example;

FIG. 6 is a block diagram showing the internal configuration of a wireless terminal device and a terminal PC in a second embodiment;

FIG. 7 is a flowchart showing the procedure of communication status level notification in a third embodiment;

FIG. 8A is schematically illustrates a first phase of an indicator unit in a fourth embodiment;

FIG. 8B is schematically illustrates a second phase of the indicator unit in the fourth embodiment;

FIG. 8C is schematically illustrates a third phase of the indicator unit in the fourth embodiment; And

FIG. 9 is a flowchart showing the procedure of communication status level notification in the fourth embodiment.

### DESCRIPTION OF THE EMBODIMENT

Although the present invention has been described and illustrated in detail, it is clearly understood that the same is by way of illustration and example only and is not to be taken by way of limitation, the spirit and scope of the present invention being limited only by terms of the appended claims.

Modes of practice of this invention will now be explained in the form of embodiments in the order named just below.

A. First Embodiment

B. Second Embodiment

C. Third Embodiment

D. Fourth Embodiment

E. Modified Examples

### A. First Embodiment

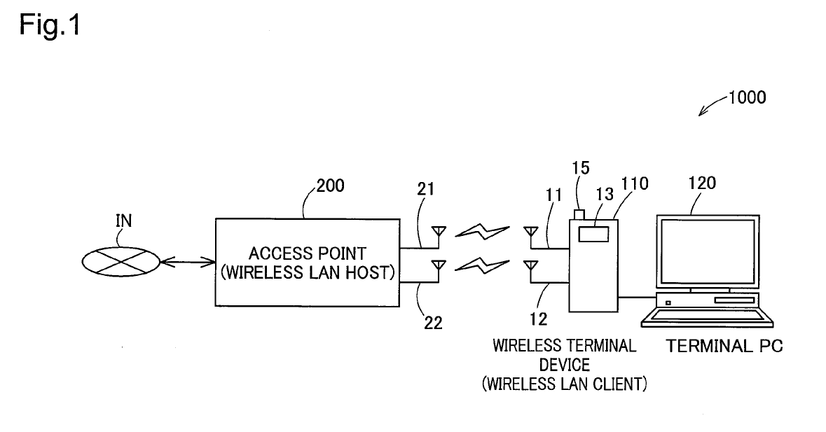

FIG. 1 is schematic view of a wireless LAN system configuration in a first embodiment. This wireless LAN system 1000 includes a wireless terminal device 110 serving as a wireless LAN client; a terminal PC 120; and an access point 200 serving as a wireless LAN host. The wireless terminal device 110 and the access point 200 are wireless relay devices that enable wireless communications between a device connected with the wireless terminal device and a network connected with the access point. The wireless terminal device 110 is connected to the terminal PC 120. The access point 200 is connected to the internet IN. The terminal PC 120 can be linked to the internet IN through wireless communication between the access point 200 and the wireless terminal device 110.

In this instance, the wireless terminal device 110 includes two antennas 11, 12, and the access point 200 also includes two antennas 21, 22. The wireless terminal device 110 and the access point 200 uses these antennas 11, 12, 21, 22 to communicate wirelessly based on the MIMO protocol. The wireless terminal device 110 is additionally provided with an indicator unit 13 which is viewable by the user, and a button 15 that can be depressed by the user. The indicator unit 13 may be composed of colored light emitting elements, such as LEDs (Light Emitting Diodes) for example. The functions of the indicator unit 13 and the button 15 are discussed later.

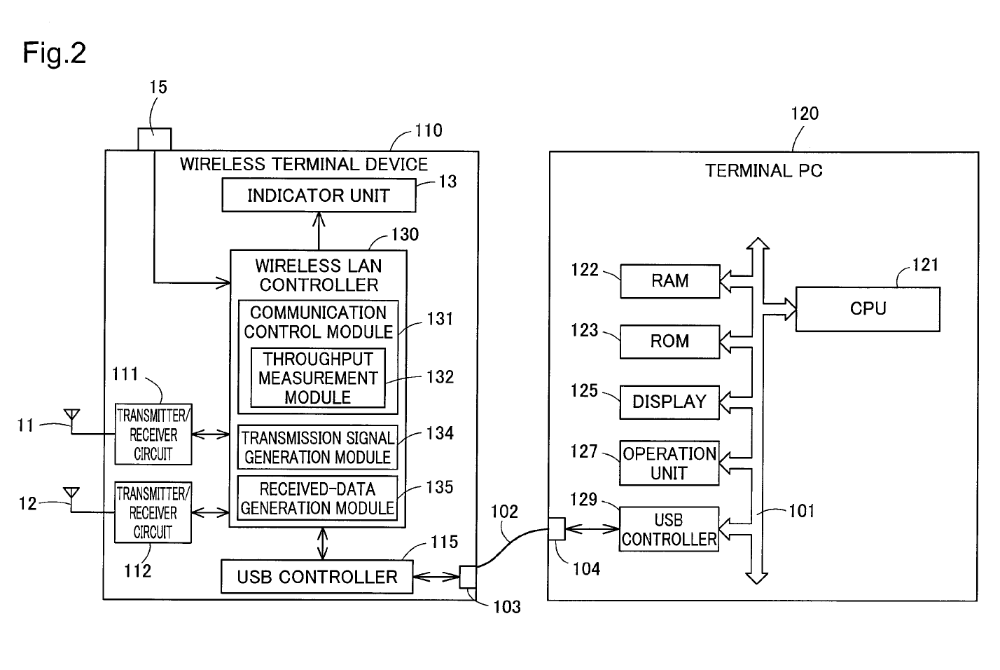

FIG. 2 shows in block diagram the internal configurations of the wireless terminal device 110 and the terminal PC 120. The wireless terminal device 110 includes a wireless LAN controller 130, two transmitter/receiver circuits 111, 112, a USB (Universal Serial Bus) controller 115, and a USB port 103. The two transmitter/receiver circuits 111, 112 are connected between the antennas 11, 12 and the wireless LAN controller 130, and perform the modulation of radio waves to be transformed and the demodulation of received radio waves, under instructions from the wireless LAN controller 130.

The wireless LAN controller 130 is implemented as a microcomputer, and controls the entire wireless terminal device 110. The wireless LAN controller 130 has a communication control module 131, a transmission signal generation module 134, and a received-data generation module 135. The communication control module 131 controls message exchanges with devices connected to the wireless terminal device 110, such as the terminal PC 120 and the access point 200.

In this instance, the communication control module 131 performs communication using the Layer 2 protocol LLD2 (Link Layer Discovery & Diagnostics). Through the LLD2 protocol, the wireless terminal device 110 exchanges messages with devices connected thereto, and can acquire information relating to the connected devices, such as their MAC addresses. The communication control module 131 also includes a throughput measurement module 132. Using the throughput measurement module 132, the communication control module 131 corresponding to the notifier of the invention executes a communication status level notification process for notifying the communication status level to the user. This process is discussed in detail later.

The transmission signal generation module 134 generates transmission signals on the basis of transmission data for transmission to the access point 200. In concrete terms, the transmission signal generation module 134 divides the transmission data and generates two transmission signal streams for the first and second antennas 11, 12. The transmission radio waves representing the generated two transmission signal streams are transmitted simultaneously in the same frequency band by the two antennas 11, 12, via the two transmitter/receiver circuits 111, 112.

The received-data generation module 135 generates received data on the basis of the signals received through the antennas 11, 12. On the basis of the distortion between the direct wave and reflected waves received through the two antennas 11, 12, the received-data generation module 135 estimates a transmission matrix of the transmission channel between itself and the access point 200. It then uses the transmission matrix to separate and reproduce from the received radio waves the original two transmission signal streams that were sent from the access point 200, and combines the two reproduced signal streams to generate the received data.

The USB controller 115 controls communication between a USB device connected to the USB port 103 and the wireless LAN controller 130. The terminal PC 120 is connected to the USB port 103 through a USB cable 102.

The terminal PC 120 includes a CPU (Central Processing Unit) 121, a RAM (Random Access Memory) 122, a ROM (Read Only Memory) 123, a display 125, a operation unit 127, a USB controller 129, and a USB port 104. The CPU 121 can load the programs stored in the ROM 123, a hard disk drive (not shown), or other external storage device into the RAM 122 (the main storage device) and execute them. The OS (Operating System) installed on the terminal PC 120 is Windows Vista (TM), for example.

The display 125 is composed of a liquid crystal display for example. The operation unit 127 includes a mouse and keyboard for example. The USB controller 129 controls communications with a USB device connected to the USB port 104. These components 121, 122, 123, 125, 127, 129 are interconnected via a bus 101.

As mentioned previously, the wireless terminal device 110 and the terminal PC 120 are connected with each other by the USB cable 102. However, the wireless terminal device 110 and the terminal PC 120 may be connected with each other through a LAN or a bus instead of a USB. The wireless terminal device 110 and the terminal PC 120 may also be integrated together.

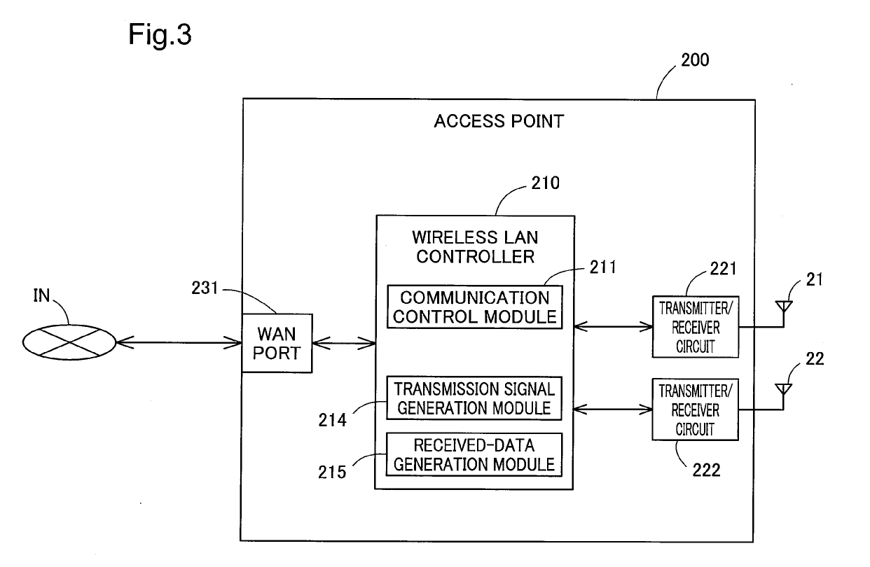

FIG. 3 is a block diagram showing the internal configuration of the access point 200. The access point 200 includes a wireless LAN controller 210, two transmitter/receiver circuits 221, 222, and a WAN (Wide Area Network) port 231. The two transmitter/receiver circuits 221, 222 are connected between the antennas 21, 22 and the wireless LAN controller 210, and perform the modulation of the radio waves to be transmitted and the demodulation of the received radio waves in accordance with the instructions from the wireless LAN controller 210.

The wireless LAN controller 210 is implemented as a microcomputer, and controls the access point 200. The wireless LAN controller 210 includes a communication control module 211, a transmission signal generation module 214, and a received-data generation module 215. The communication control module 211 controls message exchanges with the wireless terminal device 110 via the antennas 21, 22, and controls connections to the internet IN via a router (not shown) connected to its WAN port 231. Since the communication control module 211 uses the LLD2 protocol, the access point 200 can exchange messages with the wireless terminal device 110 which uses the same LLD2 protocol. The transmission signal generation module 214 and the received-data generation module 215 are similar to the transmission signal generation module 134 and the received-data generation module 135 of the wireless terminal device 110, and are used to generate transmission signals for the purpose of MIMO protocol wireless communication, and to generate received data.

As mentioned above, during MIMO protocol communications, the transmission matrix for the transmission channel is estimated on the basis of the distortion detected by comparing the direct wave and reflected waves of the transmitted signal. It is accordingly possible to reduce the adverse influence by obstacles on the transmission channel during wireless communications. However, in order to improve the communication status level, it is preferable for the user to be able to appropriately adjust the position posture and antenna orientations of the wireless terminal device 110. It is therefore preferable that the wireless terminal device 110 should have the function of providing the user with the real-time notification of the current communication status level which helps the user to appropriately adjust the position, posture and antenna orientations of the wireless terminal device 110. In this embodiment, the wireless terminal device 110 performs the communication status level notification process which is described below.

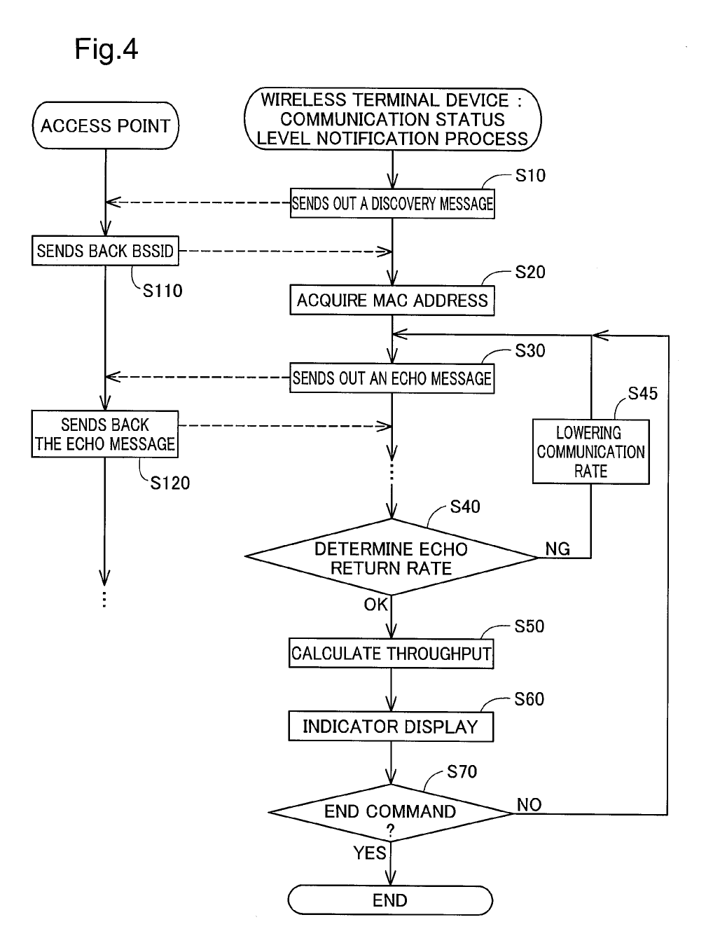

FIG. 4 is a flowchart showing the procedure of the communication status level notification performed by the wireless terminal device 110. In this communication status level notification procedure, the communication status level with respect to the access point 200 is determined through message exchange using the LLD2 protocol, and then notified to the user. Near the left margin of FIG. 4, part of the process that is executed in the access point 200 during the communication status level notification process is shown for convenience' sake.

The communication status level notification process starts when the user depresses the button 15. In Step S10, the wireless terminal device 110 sends out a Discovery message to all the devices with which it is connected. Upon receiving the Discovery message, the access point 200 responds to the wireless terminal device 110 with the BSSID (Basic Service Set Identifier) that includes the MAC address of the access point 200 (Step S110). The wireless terminal device 110 can thereby acquire the MAC address of the access point 200 (Step S20). The wireless terminal device 110 subsequently sends out messages to the access point 200 specified as the communication partner based on the acquired MAC address.

The wireless terminal device 110 then sends out an Echo message to the access point 200 (Step S30). This “Echo message” is a message of fixed length which is exchanged between the devices communicating with each other according to the LLD2 protocol, to test the connection status between the communicating devices. Upon receiving the Echo message, the access point 200 sends back the same Echo message to the wireless terminal device 110 (Step S120). The wireless terminal device 110 and the access point 200 repeat this Echo message exchange N times where N is a preselected natural number.

In this process, the throughput measurement module 132 of the wireless terminal device 110 measures the time intervals t1, t2, . . . tN, each for completing a single Echo message exchange, and stores these time intervals. Each of the measured time intervals t1, t2, . . . tN specifically represents the time interval that begins when the transmission signal generation module 134 starts the division of the data representing the Echo message to generate a transmission signal, and that ends when the received-data generation module 135 finishes reproducing the returned Echo message from the received radio wave.

In the event that the Echo message is not returned by the access point 200 after a prescribed time interval elapses subsequent to sending of the Echo message, the wireless terminal device 110 concludes that the Echo message disappeared on the communication path. It then executes the next Echo message transmission process (Step S30).

In Step S40, the wireless terminal device 110 calculates the percentage of M with respect to N (i.e. (M/N)×100) as the return rate of the Echo message; N is the number of times the wireless terminal device 110 has transmitted the Echo message, and M is the number of times the wireless terminal device 110 has received the Echo message returned from the access point 200. If this Echo message return rate is less than a prescribed value (e.g. 90% or less), the wireless terminal device 110 executes a process for lowering the prescribed rate of communication with the access point 200 (Step S45). Then, the wireless terminal device 110, having initialized the saved measurement intervals t1, t2 . . . tN, restarts the Echo message exchange with the access point 200 at this lower communication rate (Step S30). In this way, through the repeated execution of the Echo message return rate determination process of Step S40 and the communication rate lowering process of Step S45, it is possible for communication between the wireless terminal device 110 and the access point 200 to take place at an appropriate communication rate.

In Step S50, the throughput measurement module 132 of the wireless terminal device 110 calculates the throughput for Echo message exchanges with the access point 200 as described above. In other words, based on the saved measurement intervals t1, t2, . . . tN and the known amount of data contained in the Echo message, the throughput measurement module 132 calculates the throughputs for the respective Echo message exchanges, and then calculates the average of these throughputs.

In Step S60, the wireless terminal device 110 changes the display status of the indicator unit 13 according to this average value for throughput. In other words, the wireless terminal device 110 notifies, by means of the indicator unit 13, the user of the status level of communication with the access point 200, which status level corresponds to the throughput measured by the throughput measurement module 132 in relation to the communication process.

Then, when the user again depresses the button 15, the wireless terminal device 110 terminates the communication status level notification process (Step S70). Until the button 15 is depressed again, the wireless terminal device 110 repeats the process of Steps S30 to S60 after resetting the communication rate to the initial value, and thereafter the communication status level display on the indicator unit 13 is updated in real time. It is accordingly possible during the communication status level notification process for the user to adjust the position, posture and the antenna orientations of the wireless terminal device 110 in order to improve the communication status level through the reference to the display status of the indicator unit 13.

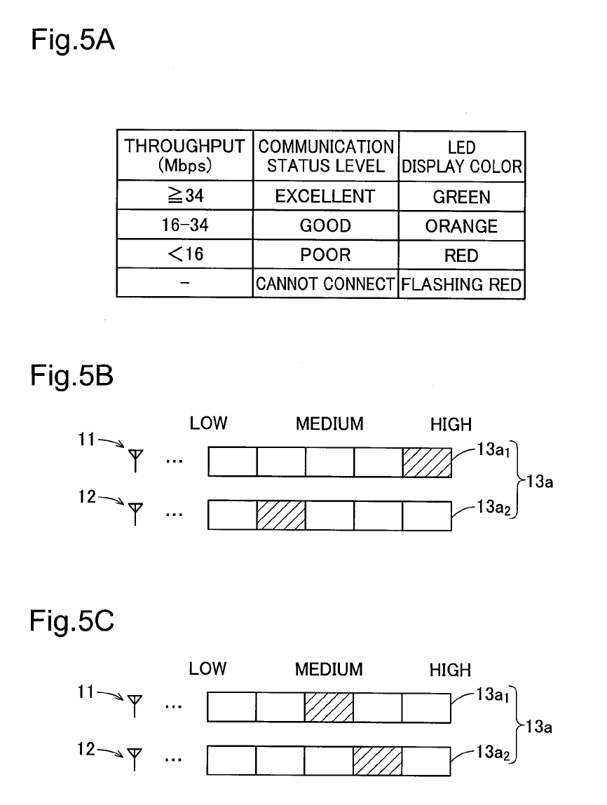

FIG. 5A illustrates an example of communication status level displays by the indicator unit 13. The indicator unit 13 of this embodiment is designed, for example, to light up green if throughput measured by the throughput measurement module 132 is 34 Mbps or higher, thereby notifying the user that the communication status is at its highest level of “Excellent”. If the measured throughput is 16 Mbps or higher but lower than 34 Mbps, the indicator unit 13 lights up orange, thereby notifying the user that the communication status is at its second highest level of “Good”. If the measured throughput is lower than 16 Mbps, the indicator unit 13 lights up red, thereby notifying the user that the communication status level is “Poor”, namely that communication is barely possible.

When communication is not possible between the wireless terminal device 110 and the access point 200, the wireless terminal device 110 switches the display status of the indicator unit 13 into flashing red to notify the user of the change in communication status level. It is, for example, when the wireless terminal device 110 cannot obtain the MAC address of the access point 200 even in steps S10˜S20 (FIG. 4), that the wireless terminal device 110 fails to communicate with the access point 200. Alternatively, the wireless terminal device 110 fails to communicate with the access point 200 when the step (Step 45) of detecting the lower communication rate senses that the communication rate has reached a preset threshold.

FIG. 5B and FIG. 5C are model diagrams depicting an indicator unit 13a of a wireless terminal device in a comparative example. Like the wireless terminal device 110 of this embodiment, the wireless terminal device of the comparative example is connected to a terminal PC 120, and performs the MIMO protocol communication with an access point 200 connected to the internet IN, by using two antennas.

The indicator unit 13a has two level bars 13a1, 13a2 provided respectively for the two antennas 11, 12. Regarding each of these two level bars 13a1, 13a2, the more intense is the electric field around the antennas 11, 12, the more rightward portion of the level bar is lit up; “rightward” being in the direction toward the right-hand side edge of the drawing sheet. In the drawing, the lit-up portions of the level bars 13a1, 13a2 are schematically represented by hatching. FIG. 5B shows an instance in which the field intensity at the first antenna 11 is relatively high and the field intensity at the second antenna 12 is relatively low. FIG. 5C shows an instance in which the field intensities at the first and second antennas 11, 12 are both of medium level.

In MIMO protocol wireless communications, transmitted data is reproduced by utilizing the distortion of the radio waves received by the antennas 11, 12. Therefore, even if the user is notified of the field intensity for each of the two antennas 11, 12, the user will find it difficult to determine the communication status level on the basis of the field intensity. That is, of the condition shown in FIG. 5B and the condition shown in FIG. 5C, it is difficult for the user to ascertain which of these conditions represents a better communication status level.

According to the wireless terminal device 110 of this embodiment, on the other hand, the communication test process (i.e. Steps S30 to S40 of FIG. 4) is executed, and the communication status level determined according to throughput is notified to the user by a single indicator unit 13. Thus, the user can easily ascertain whether or not the current communication status is sufficiently good, so that the user can easily adjust the position, posture and antenna orientations of the wireless terminal device 110. Moreover, with this wireless terminal device 110, even if there is considerable distance between the wireless terminal device 110 and the terminal PC 120, the user can adjust the position, posture and antenna orientations of the wireless terminal device 110 while observing the lighting status of the indicator unit 13.

In this way, the wireless LAN system 1000 of this embodiment can appropriately notify the user the status level of the communication between the wireless terminal device 110 and the access point 200, thus providing enhanced convenience for the user in wireless communications.

### B. Second Embodiment:

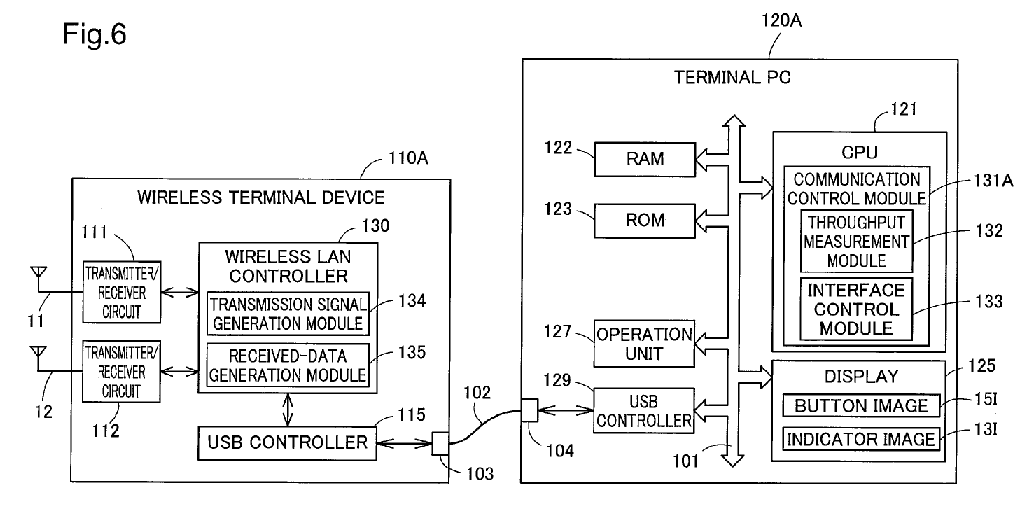

FIG. 6 is a schematic view of a wireless LAN system according to a second embodiment of the invention, and shows the internal configurations of a wireless terminal device 110A and a terminal PC 120A. FIG. 6 is substantially identical to FIG. 2 except the following details. In FIG. 6, the wireless terminal device 110A of FIG. 6 lacks the communication control module 131, the indicator unit 13, and the button 15. Also, in FIG. 6, the CPU 121 of the terminal PC 120A is provided with a communication control module 131A; and the display 125 is provided with an indicator image 131 and a button image 151. In other respects, the wireless LAN system configuration in the second embodiment is similar to the LAN system 1000 configuration in the first embodiment (FIG. 1, FIG. 3), and executes the same communication status level notification process (FIG. 4) as described in the first embodiment.

According to the wireless LAN system in the second embodiment, during wireless communications, the CPU 121 of the terminal PC 120A executes a program having the functions of the communication control module 131A. Except for an interface 133, the communication control module 131A is substantially identical to the communication control module 131 of the wireless terminal device 110 described in the first embodiment.

The interface 133 displays interface images relating to wireless communications on the display 125. To be concrete, the interface 133 displays on the display 125 such interface images as the button image 151 for instructing the start of the communication status level notification process and as the indicator image 131 for indicating the communication status level. The button image 151 is an image that the user can click on with a pointer displayed on the display 125. Like the indicator unit 13 of the first embodiment, the indicator image 131 notifies the user of the communication status level in different colors (FIG. 5A).

In the wireless LAN system of the second embodiment, the execution of the communication status level notification process is started in the terminal PC 120 when the user clicks on the button image 151 displayed on the display 125. In the communication status level notification process, the display color of the indicator image 131 changes according to the results of the measurements of throughput made by the throughput measurement module 132.

According to the wireless LAN system of the second embodiment, just as according to that of the first embodiment, it is possible to appropriately notify to the user, via the display 125, the level of communication status between the wireless terminal device 110A and the access point 200. Moreover, it is possible to make the wireless terminal device 110A more compact than the wireless terminal device 110 of the first embodiment. In the wireless LAN system of the second embodiment, it is preferable to integrate the wireless terminal device 110A and the terminal PC 120A together. In this way, the user can adjust the position, posture and antenna orientations of the wireless terminal device 110A while observing the indicator image 131 shown on the display 125.

### C. Third Embodiment:

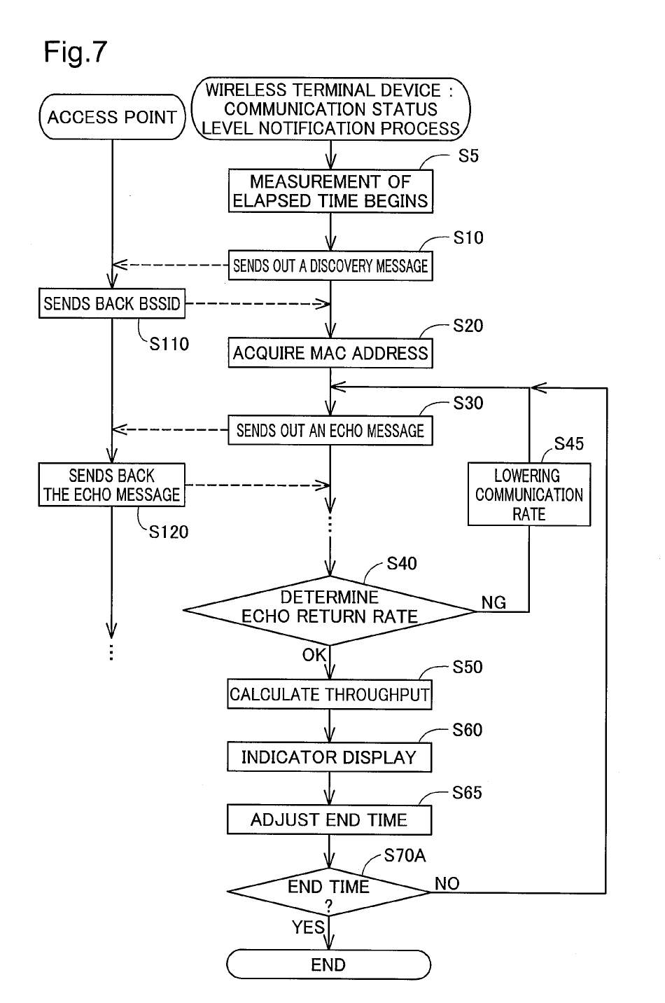

FIG. 7 is a flowchart for the communication status level notification process performed in the wireless LAN system according to a third embodiment of the invention. FIG. 7 is substantially identical to FIG. 4, except that a Step S5 and a Step S65 are added, and the Step S70 is replaced by a Step S70A. The wireless LAN system configuration of the third embodiment is the same as that of the wireless LAN system 1000 of the first embodiment.

When the communication status level notification process of the third embodiment is initiated, the measurement of elapsed time begins (Step S5). Then, part of the process beginning with Step S30 is repeated until the continuous running time of the communication status level notification process exceeds a prescribed end time Tend; and the communication status level notification process terminates automatically once the end time Tend is exceeded (Step S70A).

Here, if the communication status level is “Poor” or “Cannot Connect” (FIG. 5A), the end time Tend is extended in Step S65. That is, if the communication status level is low, the time interval during which the user can adjust the position, posture and antenna orientations of the wireless terminal device 110A while observing the indicator unit 13, can be extended. On the other hand, if the communication status level is “Excellent”, the end time Tend is shortened in Step S65. Consequently, the situations in which the communication status level notification process continues uselessly, possibly resulting in a decline in wireless communication throughputs, can be avoided.

In the communication status level notification process of the third embodiment, the time interval during which the user can adjust the position, posture and antenna orientations of the wireless terminal device 110A while observing the indicator unit 13 is adjusted automatically according to the communication status level. Therefore, the usability can be said to be improved.

### D. Fourth Embodiment:

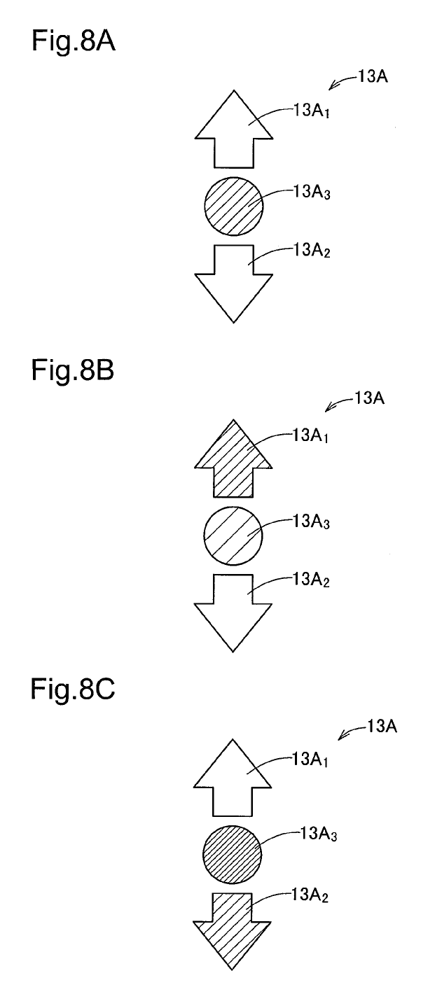

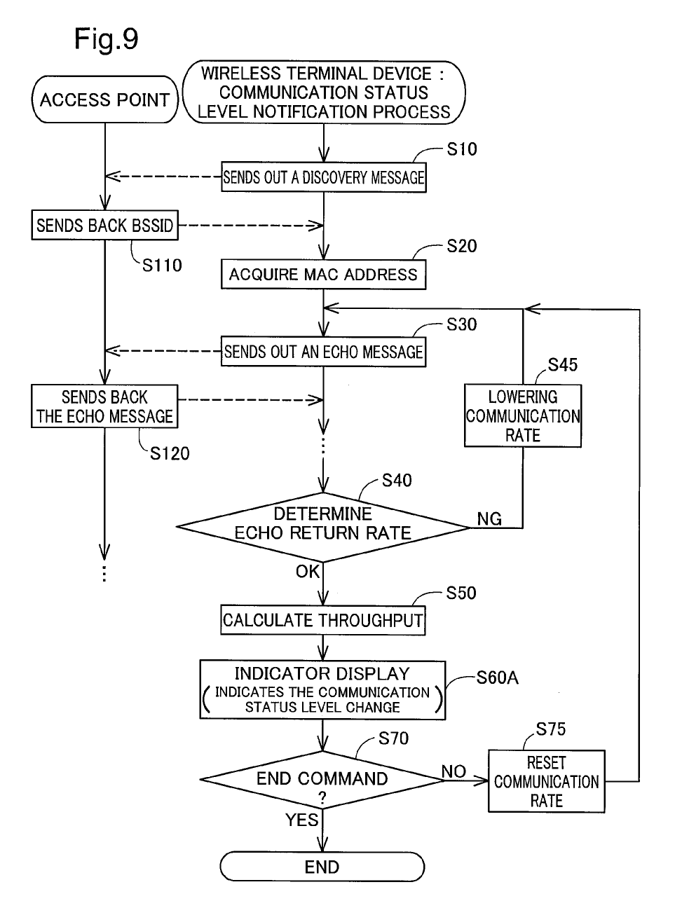

FIGS. 8A to 8C are model diagrams illustrating an indicator unit incorporated in a wireless terminal device of a wireless LAN system according to a fourth embodiment of the invention. The configuration of the wireless LAN system in the fourth embodiment is the same as that of the wireless LAN system 1000 of the first embodiment, except that an indicator unit 13A is provided in place of the indicator unit 13 in the wireless terminal device 110 (FIGS. 1, 2, 3). FIG. 9 is a flowchart showing the communication status level notification process in the fourth embodiment. FIG. 9 is substantially identical to FIG. 4, except that the Step S60 is replaced by a Step S60A, and a Step S75 is added.

The indicator unit 13A incorporated in the wireless terminal device 110 of the fourth embodiment has three light emitting sections 13A1, 13A2, 13A3 (FIGS. 8A to 8C). The first light emitting section 13A1 is in the shape of an upward-pointing arrow, and the second light emitting section 13A2 is also in the shape of a downward-pointing arrow. The third light emitting section 13A3 lies vertically between the ends of the first and second light emitting sections 13A1, 13A2. In the drawings, for illustration, the hatched sections are to be regarded as being currently energized to emit light, and the different types of hatching indicate different color lights.

In Step S60A of the communication status level notification process (FIG. 9), the communication status level is indicated through the color of light emitted by the third light emitting section 13A3 (FIG. 8A). In concrete terms, the levels are displayed as described with FIG. 5A. The parts of the process consisting of Steps S30 to S50 are then repeated. If the communication status level indicated now is higher than that indicated previously, the first light emitting section 13A1 lights up to notify the user that the communication status level has upgraded (FIG. 8B). Conversely, if the presently displayed communication status level is lower than the previously displayed communication status level, the second light emitting section 13A2 lights up to notify the user that the communication status level has degraded (FIG. 8C).

According to the fourth embodiment, the adjustment of the rate of communication between the wireless terminal device 110 and the access point 200 is executed (Step S75) when the steps following Step S30 are again executed after Step S60A (FIG. 9) and Step S70. If the communication status level tends to upgrade, the communication rate is reset to the initial value (maximum value), whereas if the communication status level tends to degrade, the communication rate is maintained at its previous rate. It is therefore possible to avoid the situation in which the communication rate remains set at a low level despite the fact that the communication status level is upgrading. It is also possible to avoid the situation in which the communications test steps of Steps S30 to S40 is executed at an unnecessarily high communication rate corresponding to a higher communication status level when the communication status level is degrading.

If the communication status level is upgrading, the communication rate may be reset, in Step S75, to a communication rate higher by a prescribed value than the previous communication rate. Consequently, if the location, posture and antenna orientations of the wireless terminal device 110 are improved and if the communication status level continues to upgrade, the communication rate setting also improves progressively so that the communication rate can be set more appropriately.

With the indicator unit 13A of the fourth embodiment, the user can easily ascertain through the display of the indicator unit 13A whether the location, posture and antenna orientations of the wireless terminal device 110 have been improved as a result of his/her adjustment. In Step S75, if the position, posture and antenna orientations of the wireless terminal device 110 were adjusted, the rate of communication between the wireless terminal device 110 and the access point 200 is reset more appropriately according to the result of the adjustment. Accordingly, user convenience in wireless communications can be enhanced further.

### E. Modified Examples:

It is to be understood that this invention is by no means limited to such embodiments and modes of practice as described above and that various modifications can be contrived within the scope of the invention. For example, the following variations can be proposed.

### E1. First Modified Example:

Part of the system configuration implemented through software in the preceding embodiments may instead be implemented by hardware, and conversely part of the system configuration implemented by hardware in the preceding embodiments may instead be implemented through software. For example, part of the function of the transmission signal generation module 134 or the received-data generation module 135 may be executed by the transmitter/receiver circuits 111, 112.

### E2. Second Modified Example:

In the preceding embodiments, the wireless terminal device 110 was equipped with two antennas 11, 12. However, the wireless terminal device 110 may be equipped with more than two antennas. In that case, the wireless terminal device 110 would divide a series of the transmission data into n transmission signal segments to be transmitted from n antennas. Similarly, the access point 200 may be equipped with more than one antenna.

### E3. Third Modified Example:

In the preceding embodiments, the LLD2 protocol was employed for communications between the wireless terminal device 110 and the access point 200. However, communications between the wireless terminal device 110 and the access point 200 may instead be performed by using a different Layer-2 protocol, or using a protocol of a layer higher than Layer 2, such as TCP/IP or FTP. Where the LLD2 protocol is employed, the MAC addresses of the connected devices can be acquired relatively easily, and communications specifically directed to the connected devices can take place easily, so that the usability of wireless communications can be improved.

Also, in the preceding embodiments, the terminal PC 120 was assumed to have Windows Vista installed as its OS, but may instead be operated by a different OS. However, Windows Vista includes the LLD2 protocol, and if the terminal PC 120 runs on Windows Vista, the LLD2 protocol is preferably used for wireless communications.

### E4. Fourth Modified Example:

In the preceding embodiments, the throughput measurement module 132 measured the throughput during exchange of an Echo message between the wireless terminal device 110 and the access point 200. However, the throughput measurement module 132 may instead measure the throughput in the process of transmitting/receiving data other than an Echo message. If the throughput in the ongoing communication is measured by using the communication test function that the protocol being used includes, such as the exchange of Echo message, then the measurement of the communication status level can be easily and properly performed. Therefore, the throughput measurement during the exchange of Echo message still proves preferable. The throughput measurement module 132 preferably measures the throughput of the entire data transmission/reception process including the throughputs with respect to the transmission signal generation module 134 and the received-data generation module 135.

### E5. Fifth Modified Example:

In the preceding embodiments, the wireless terminal device 110 performed communication in infrastructure mode while connected to the access point 200. However, the wireless terminal device 110 may be connected to a different wireless communication device. For example, the wireless terminal device 110 may be connected to an external wireless terminal device for wireless communications in ad-hoc mode.

### E6. Sixth Modified Example:

In the preceding embodiments, different colors of light emitted by the LED of the indicator unit 13 were used to notify the communication status level to the user. However, notification may be performed by another method instead of notification through the indicator unit 13. As other examples, notification may resort to visual methods using numerical displays, or to auditory methods using voices.

### E7. Seventh Modified Example

In the preceding embodiments, two or more wireless terminal devices 110 may connect to the access point 200 in the wireless LAN system 1000. Alternatively, two or more access points 200 may be interconnected through wires.

### E8. Eighth Modified Example:

Features described in the preceding embodiments may be combined appropriately. For example, the communication status level notification process of the third embodiment may be employed in the wireless LAN system of the second embodiment; or the notification by the indicator unit 13A in the fourth embodiment may be substituted for the display unit 125. The notification by the indicator unit 13A in the fourth embodiment may be employed in the communication status level notification process of the third embodiment.

What is claimed is:

1. A wireless terminal device for communicating with an external wireless communication device through MIMO protocol, comprising:
a throughput measurement for measuring the throughput of the process of communicating with the wireless communication device; and
a level notifier for notifying to a user the level of the status of communication with the wireless communication device according to the result of the measurement by the throughput measurement.

2. The wireless terminal device according to claim 1, wherein the level notifier:
causes the throughput measurement to initiate the process of measuring the throughput in response to an instruction from the user;
initiates the process of notifying the communication status level according to the throughput measurement result; and
continues the measurement process and the notification process only during the measurement time interval adjusted according to the throughput measurement result.

3. The wireless terminal device according to claim 1, wherein the level notifier notifies the user of whether the change in the communication status level exhibits an upgrading tendency or a degrading tendency.

4. A wireless communication system comprising:
a wireless terminal device according to claim 1; and
an access point capable of wireless communication with the wireless terminal device through MIMO protocol.

5. A method of notifying the status level of communication with an external wireless communication device to the user, the method being used in a wireless terminal device that communicates with the wireless communication device through MIMO protocol, and the method comprising the steps of:
(a) calculating the throughput of the communication with the wireless communication device; and
(b) notifying the communication status level according to the throughput measurement result.
